(19) United States
(12) Patent Application Publication
(10) Pub. No.: US 2020/0276459 A1
(43) Pub. Date: Sep. 3, 2020

(54) SAFETY SYSTEM INCLUDING EVACUATION SLIDE AND FLOATATION RAFT, AND METHODS OF USE

(71) Applicant: Winsome COLLIER, Queens (US)

(72) Inventor: Winsome COLLIER, Queens, NY (US)

(21) Appl. No.: 16/759,633

(22) PCT Filed: Oct. 25, 2018
(86) PCT No.: PCT/US2018/057502

§ 371 Date: Apr. 27, 2020

Related U.S. Application Data
(60) Provisional application No. 62/576,871, filed on Oct. 25, 2017.

(51) Int. Cl. A62B 1/20; B63C 9/04

(52) U.S. Cl. CPC A62B 1/20; B63C 2009/0029; B63C 9/04

(57) ABSTRACT

An emergency system is disclosed that includes an elongated inflatable slide portion that in the inflated condition has an upper end portion, an enlarged lower end portion and a middle portion therebetween, the slide portion optionally further includes a pair of raised side portions to assist with retaining an evacuee on the slide portion. The system is moveable from a ready position inside the building to a deployed position outside the building, wherein, in an embodiment, a release button in the ready position is arranged and configured to face an interior wall of the building, and in the deployed position is arranged and configured to face outward and be readily accessible by a potential evacuee. The slide may optionally include side support members, one or more securement straps, and other features.

### BACKGROUND

The present invention relates to an emergency or evacuation system that includes an inflatable slide and/or emergency floatation raft to provide safe escape from a building in an emergency situation, such as, for example, a burning building.

The use of evacuation slides is known in the prior art. The known evacuation slides are primarily associated with aircraft. Evacuation slides have also been used for buildings. The evacuation slides used for building are generally secured to the exterior of the building which exposes the evacuation slide to the harsh external environment including heat, UV exposure, cold and moisture. Such exposure can be detrimental to the performance and longevity of the slide.

Known evacuation slides for building also require installation on the exterior of the building which may require retrofitting the building and add installation costs to the evacuation system. This exists a need for an emergency evacuation system that provides escape from a building in an emergency situation that is cost effective, durable, easy-to-use, in embodiments is portable, and permits safe non-injurious escape.

### SUMMARY OF THE INVENTION

The present disclosure is directed to a person of ordinary skill in the art. The purpose and advantages of the emergency system including evacuation slide and/or emergency raft will be set forth in, and be apparent from, the drawings, description, and claims that follow. The summary of the disclosure is given to aid understanding of the evacuation slide and/or emergency raft system, and not with an intent to limit the disclosure or the invention. It should be understood that each of the various aspects and features of the disclosure may advantageously be used separately in some instances, or in combination with other aspects and features of the disclosure in other instances. Accordingly, while the disclosure is presented in terms of embodiments, it should be appreciated that individual aspects of any embodiment can be utilized separately, or in combination with aspects and features of that embodiment or any other embodiment. In accordance with the present disclosure, variations and modifications may be made to the evacuation slide and/or emergency raft system to achieve different effects.

The present disclosure is directed to a new improved inflatable slide for securing to a building to provide an escape passage that in embodiments may also serve as an emergency floatation raft. It will be appreciated that the improved inflatable slide is user friendly, cost effective and durable. It will be appreciated that the inflatable slide/emergency raft system is easily and efficiently manufactured. It will be further appreciated that the new and improved inflatable slide/emergency raft is of durable and reliable construction. It will also be appreciated that the new and improved inflatable slide/emergency raft is packaged and configured to be stored inside the building, so as not to be exposed to the harsh exterior environmental conditions which would be detrimental to the durability, longevity and operability of the inflatable slide/emergency raft.

It will be appreciated that the new and improved inflatable slide/emergency raft system is attachable to a building in proximity of an egress opening, e.g., a window, and is susceptible of low cost of manufacture and low cost of installation thereby making the system economically available to the consuming public, and which provides reliable, easy-to-use, safe escape from a building in an emergency situation. It will be appreciated that embodiments of the new and improved inflatable slide/emergency raft system are portable thereby allowing the system to be carried and/or used in emergency vehicles, e.g., fire trucks and ambulances. The following attributes will become clarified and set forth by the disclosure herein.

In one embodiment, an emergency system securable to a building, which has an egress opening (e.g., a window opening) located above a ground surface for providing egress, preferably in an emergency situation, is disclosed. The system may comprise a ready state and an inflated state, wherein in the ready state the system is uninflated and in a packaged more compact and smaller condition, and wherein in the inflated state the system is inflated into a larger inflated condition. The system further comprises in one embodiment an elongated self-inflating slide portion that in the inflated condition has an upper end portion, an enlarged lower end portion and a middle portion therebetween, the slide portion optionally further includes a pair of raised side portions to assist with retaining an evacuee on the slide portion. The upper end portion preferably is securable to the building, preferably the interior of a building, where it may be maintained in the ready state. The slide portion preferably is configured to have a length in its inflated state that is larger than the distance between the ground and the egress opening the system is associated with such that, for example, the enlarged lower end portion creates an obtuse angle with a top sliding surface of the middle portion.

The system may according to one aspect include a release button for converting the slide from the ready state to the inflated state by inflating the slide portion. The system in a packaged condition may be moveable from a ready position inside the building to a deployed position outside the building, wherein the release button in the ready position is arranged and configured to face an interior wall of the building, and in the deployed position is arranged and configured to face outward and be readily accessible by a potential evacuee.

The slide may further include one or more securement straps attached to the upper end portion of the slide portion, the one or more securement straps configured for securing to the building. The securement straps preferably are securable to the inside of the building where the straps are not exposed to the harsh exterior environmental conditions, which may prematurely effect the condition of the securing straps and the inflatable slide. The securement straps have a first end preferably releasably attachable to the upper end portion of the slide, and a second end preferably releasably attachable to the inside of the building, the one or more securement straps attachable by at least one of a securing bolt, U-shaped hook members, and combinations thereof to the building. Other mechanisms for attaching and/or securing the slide to the building, preferably the interior of the building, are contemplated.

The release button in one embodiment is configured to be pulled by a user to inflate the system to the inflated condition, wherein pulling the release button releases the compressed gas, e.g., by releasing one or more pins of one or more compressed gas canisters, to inflate and deploy the inflatable slide. In an embodiment, the compressed gas canister preferably includes CO₂, and preferably consists essentially of CO₂. The slide portion may include a plurality of compressed gas canisters arranged, configured and spaced apart along the length of the slide portion which during inflation of the slide portion are triggered in sequence to release gas and inflate the slide portion as the slide portion unrolls from its packaged condition to its deployed condition. The inflatable slide may include an aspirator associated with and activated by the release button to draw air into the slide portion to inflate the slide portion. The system and/or its packaging (including labels) may further be configured to be color coded based upon the length of the slide portion.

The inflatable slide may optionally include a tubular section associated with the top portion that extends along a portion of the length of the slide portion. The tubular section may be configured to enclose at least a portion of the top end portion of the slide in an inflated state to retain an evacuee within and prevent falling off and out of the evacuation slide. The tubular section may extend from the top portion to approximately 20 feet from the enlarged lower end portion. The tubular section or a portion thereof preferably is substantially transparent or translucent, and preferably formed of fire resistant or retardant material. The inflatable slide may further include in the inflated condition a plurality of raised sections configured to extend transverse to the length of the slide portion and dispersed at a plurality of locations along the length of the slide portion to control the descent velocity of an evacuee as they slide down the slide portion. The inflatable slide and or its packaging may further include one or more sensors to detect an emergency situation, such as, for example, heat, smoke, CO₂, and may further comprise an alarm system that provides a visible and/or auditory alarm.

The inflatable slide may in one embodiment include a plurality of independently inflatable channels running the length of the slide portion. The lower enlarged end portion may be configurable in the inflated condition to rest on the ground and an upper surface of the enlarged lower end portion configurable to be one and a half (1.5) feet to two (2) feet above the lower surface. The enlarged lower end may further include foam, and in one embodiment the slide portion may have a foam layer on the underside of at least a portion of the slide portion. The slide in the ready state may be configured and arranged to be portable and may include a handle to assist with moving the slide in the ready state. One or more wheels may be provided to assist with moving the slide in the ready state or packaged condition.

The inflatable slide in one embodiment optionally includes side support members, the support members positioned and arranged along package sides in the packaged condition. The side support member may be associated with and positioned along the raised side portions of the upper end portion of the slide in the inflatable condition to provide support to the slide portion. The side support members may be made of at least in part heat resistant plastic. The side support members may be releasably attachable to the slide portion. Each side support member may include two connectable sections that are moveable with respect to each other between a first position and a second position. In the first position, the two connectable sections are at an angle with respect to each other, and in the second position, the two connectable sections are aligned in a substantially straight line. In the packaged condition, the first connectable section in the first position is connected along one side of the packaged slide and the second connectable section is positioned along the bottom surface of the packaged slide. In one embodiment, the second connectable section of the side support member may include one or more wheels. The side support members in one configuration have a handle portion for gripping the inflatable slide in the ready state for moving the slide.

The one or more side support members preferably are configured to be releasably attached to the slide and may be detached to form oars. In one embodiment, the system is releasably securable to the building to form an emergency floatation raft.

The inflatable slide optionally may include a safety system, the safety system including a pair of cables associated with the raised side portions, each of the cables having an attachment cord configured for attachment to a potential evacuee and attachable to and moveable along the cable to secure an evacuee during descent.

There has thus been outlined, rather broadly, the features of an evacuation system in order that the detailed description thereof that follows may be better understood, and in order that the present contribution to the art may be better appreciated. There are, of course, additional features of the invention that will be described hereinafter and which will form the subject matter of the claims appended hereto.

### BRIEF DESCRIPTION OF THE DRAWINGS

The various aspects, features, and embodiments of the system, including the evacuation slide and/or emergency raft, as disclosed herein will be better understood when read in conjunction with the drawings provided. Embodiments are provided in the drawings for the purposes of illustrating aspects, features and/or various embodiments of the system, e.g., evacuation slide and/or emergency raft, but the claims should not be limited to the precise arrangement, structures, subassemblies, features, embodiments, aspects, and devices shown, and the arrangements, structures, subassemblies, features, embodiments, aspects, and devices shown may be used singularly or in combination with other arrangements, structures, subassemblies, features, embodiments, aspects, and/or devices. The drawings are not necessarily to scale and are not in any way intended to limit the scope of the claims, but are merely presented to illustrate and describe various embodiments, aspects and features of the system, including embodiments, aspects and features of the evacuation slide and/or emergency raft, to one of ordinary skill in the art.

FIG. 1 is a top view of an embodiment of an inflatable evacuation slide system in an inflated state.

FIG. 2 is a side view of an embodiment of an inflatable evacuation slide system in an inflated state.

FIG. 3 is a side perspective view of the lower end portion of an embodiment of an inflatable evacuation slide system in an inflated state.

FIG. 4 is a top view of an upper portion of an embodiment of an inflatable evacuation slide system in an inflated state.

FIG. 5 is a cross-sectional view of an upper portion of an embodiment of an inflatable evacuation slide system in an inflated state.

FIG. 6 is a top view of an upper portion of an embodiment of an inflatable evacuation slide system in an inflated state.

FIG. 7 is a side perspective view of an embodiment of an inflatable evacuation slide system in a ready state in a ready position.

FIG. 8 is a side perspective view of an embodiment of an inflatable evacuation slide system in a ready state in a deployed position.

FIGS. 9A is a view of the inflatable evacuation slide system in the ready state in the deployed position just before the release button is activated.

FIGS. 9B, 9C and 9D are side views of an inflatable evacuation slide system as it expands from the ready state in FIG. 9A through intermediate inflation states in FIGS. 9B, 9C, and 9D.

FIG. 10 is a top view of an embodiment of an inflatable evacuation slide as it converts from the ready state to the inflated state.

FIG. 11 is a side view of an embodiment of an inflatable evacuation slide in the ready state, while FIG. 11A is an enlarged view of the release button and canister from FIG. 11.

FIG. 12A is a side view of an embodiment of the release button with tension wires for pulling the trigger pins of compressed gas canisters.

FIG. 12B is a side view of the inflatable slide system with inflation canisters.

FIG. 12C is rear side view of an underside of an inflatable evacuation slide system in accordance with one embodiment.

FIG. 13 is a side perspective view of a portable embodiment of an inflatable evacuation slide system in a ready state.

FIG. 14 is a side perspective view of a top end portion of an embodiment of an inflatable evacuation slide system in an inflated state used as a floatation raft.

FIG. 15 is a back elevation view of an embodiment of an inflatable evacuation slide in a ready state.

FIG. 16 is side view of side support members in one embodiment converted to oars for use with the evacuation slide/emergency raft.

FIG. 17 shows the release mechanism for the side support members according to one embodiment.

The same reference numbers refer to the same parts throughout the various figures.

### DETAILED DESCRIPTION

In the following detailed description, numerous details are set forth in order to provide an understanding of an evacuation slide and/or emergency raft, the system, and its method of operation and use. However, it will be understood by those skilled in the art that the different and numerous embodiments of the evacuation slide and/or emergency raft system, and its method of operation and use may be practiced without these specific details, and the claims and invention should not be limited to the embodiments, subassemblies, or the specified features or details specifically described and shown herein. The description provided herein is directed to one of ordinary skill in the art and in circumstances, well-known methods, procedures, manufacturing techniques, components, and/or assemblies have not been described in detail so as not to obscure other aspects, or features of the evacuation slide and/or emergency raft.

Accordingly, it will be readily understood that the components, aspects, features, elements, and subassemblies of the embodiments, as generally described and illustrated in the figures herein, can be arranged and designed in a variety of different configurations in addition to the described embodiments. It is to be understood that the evacuation slide and/or emergency raft, and system may be used with many additions, substitutions, or modifications of form, structure, arrangement, proportions, materials, and/or components which may be particularly adapted to specific environments and operative requirements without departing from the spirit and scope of the invention.

The following descriptions are intended only by way of example, and simply illustrate certain selected embodiments of a system including an evacuation slide and/or emergency raft. For example, while the evacuation slide and/or emergency raft is shown and described in examples with particular reference to its use in connection with a window opening, and in connection with a fire, it should be understood that the evacuation slide and/or emergency raft will have other applications as well. In this regard, the description utilizes the term inflatable slide but one should recognize that use of the term slide is intended to be inclusive of the system and combination slide/emergency raft. In addition, while the detailed description in many examples is generally directed to an evacuation slide that has features beneficial for use as an emergency raft, it will be appreciated that the disclosure and teachings have application to other materials and designs that would not utilize features beneficial for use as an emergency raft, such as, for example, by eliminating the buoyant foam. The invention shall be set forth by the claims which should be broadly construed to cover evacuation slides and/or emergency rafts, unless otherwise clearly indicated to be more narrowly construed to exclude embodiments, elements and/or features of the evacuation slide and/or emergency raft.

Throughout the present application, reference numbers are used to indicate a generic element or feature of the system, evacuation slide, and/or emergency raft. The same reference number may be used to indicate elements or features that are not identical in form, shape, structure, etc., yet which provide similar functions or benefits. Additional reference characters (such as letters, primes, or superscripts, as opposed to numbers) may be used to differentiate similar elements or features from one another. It should be understood that for ease of description the disclosure does not always refer to or list all the components of the system, evacuation slide, and/or emergency raft, and that a singular reference to an element, member, or structure, e.g., a singular reference to a securement strap, raised side portion, safety cable, attachment cord, wheel, support member, may be a reference to one or more such elements, unless the context indicates otherwise.

In the following description of various embodiments of the system, evacuation slide, and/or emergency raft, it will be appreciated that all directional references (e.g., proximal, distal, upper, lower, upward, downward, left, right, lateral, longitudinal, front, rear, back, top, bottom, above, below, vertical, horizontal, radial, axial, interior, exterior, clockwise, and counterclockwise) are only used for identification purposes to aid the reader's understanding of the present disclosure unless indicated otherwise in the claims, and do not create limitations, particularly as to the position, orientation, or use in this disclosure. Features described with respect to one embodiment typically may be applied to another embodiment, whether or not explicitly indicated.

Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings may vary.

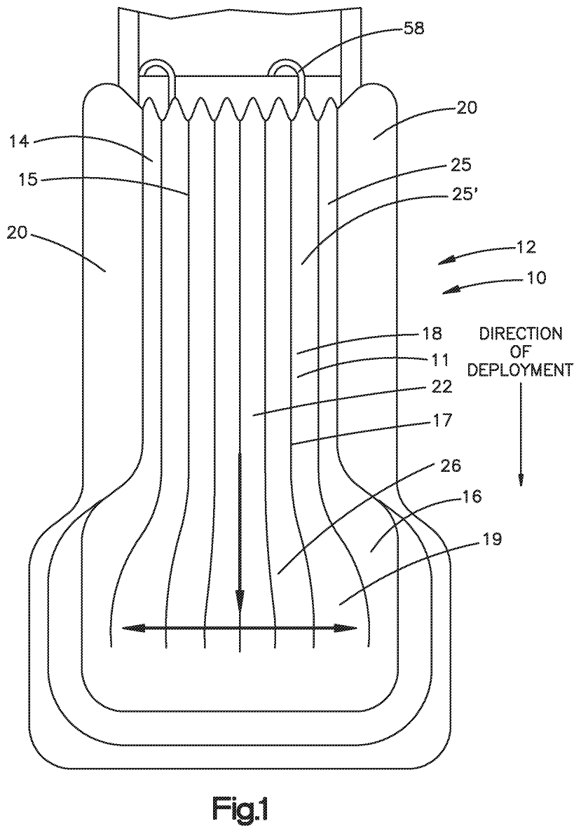

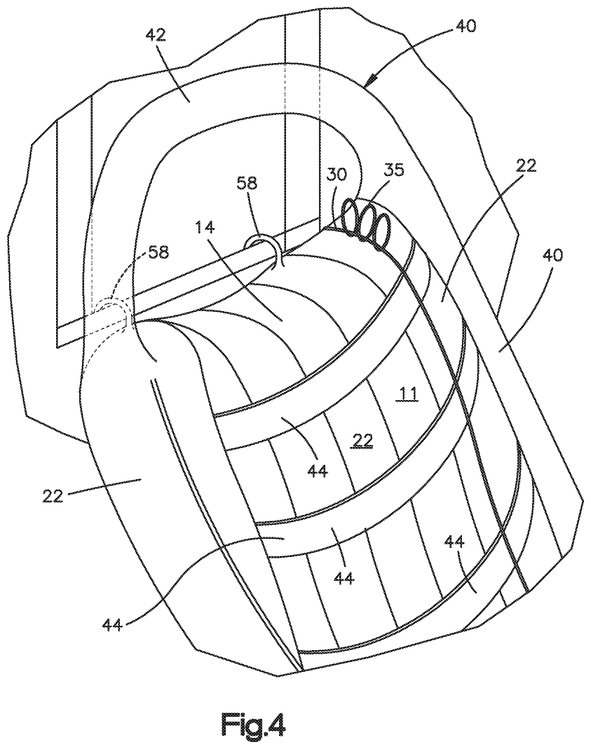

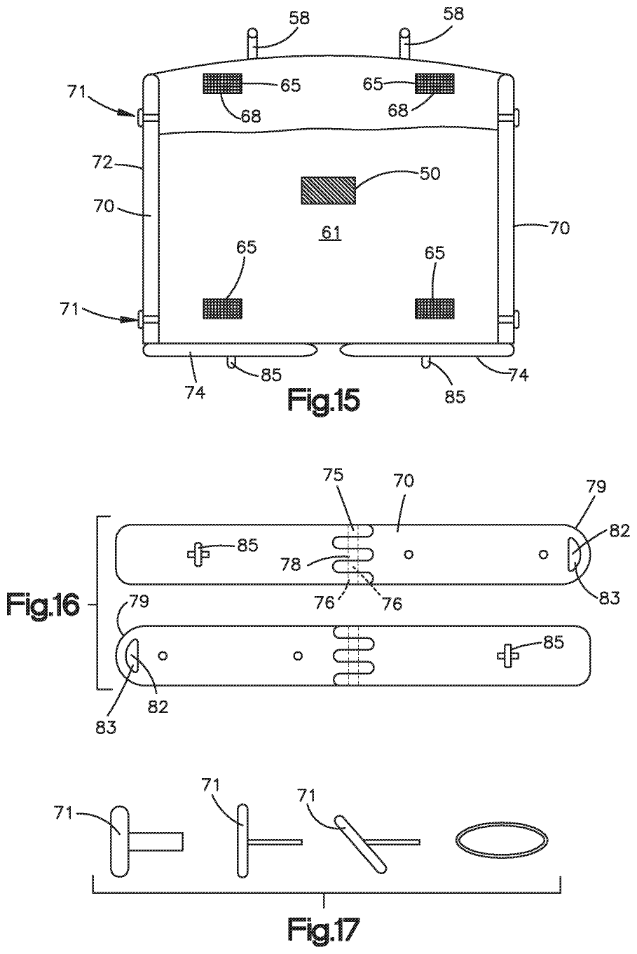

With reference to the drawings, and in particular to FIGS. 1-17, preferred embodiments of the new and improved inflatable slide and/or emergency raft providing egress in an emergency situation from buildings having egress openings located above a ground surface embodying, disclosing, and teaching various concepts and principles is discussed. It will be noted in the various figures that the device, system and/or method relates to an inflatable slide for providing egress in an emergency situation from buildings, such as, for example, to provide safe escape from a burning building, and/or an emergency raft to provide safety in water conditions, e.g., a flood situation. In one context the device, system and/or method includes an elongated self-inflating slide portion which in one embodiment has an attachment mechanism to secure the slide to the building, preferably the interior of the building, and permit movement of the slide from a ready position inside the building to a deployment position outside the building. In one embodiment, the inflatable slide includes one or more securement cables or straps attachable, preferably releasably attachable, to the slide and attachable, preferably in an embodiment releasably attachable, to the building to secure the inflatable slide to the building. The components and features are individually and collectively configured and correlated with respect to each other to attain the desired objectives.

The inflatable slide generally has two states or conditions including a ready state or packaged condition wherein the slide is uninflated and packaged to be smaller, more compact and preferably readily moveable by a user or potential evacuee, and an inflated state or condition where the slide is inflated into a larger size and configured to provide an escape from the floors above ground level in a dangerous situation. During deployment and/or inflation, the slide changes or converts from the ready state to the inflated state. In the inflated state, the slide is usable by potential users and/or evacuees to descend from an egress opening in a building, such as, for example, a window, door, escape hatch, or similar opening, that is located above ground to a ground surface or other location. The slide is also movable from various positions including a ready position inside a building to a deployment position located outside and preferably secured to the building.

Turning first to the configuration of the slide in its inflated state or inflated condition, as shown in FIGS. 1-3, the slide 10 may comprise an elongated self-inflating slide portion 12, having an upper end portion 14, an enlarged lower end portion 16, and a middle portion 18 extending between the upper end portion and the enlarged lower end portion. The slide portion 12 in one embodiment may include a pair of raised side portions 20 extending a length of the sliding portion 12 and a central sliding portion 22 disposed and located between the raised side portions 20. The evacuee would slide down the central sliding portions 22 while the raised side portions 20 would resist and help prevent the evacuee from falling off the slide 10. While it is preferable that the raised side portions 20 run the length of the slide portion 12, it is contemplated that the raised side portions 20 may extend only the length of the upper end portion 14, the middle portion 18, and/or the enlarged lower end portion 16, or any combination thereof (e.g., the upper end portion 14 and the middle portion 18). The width of the central portion 22 in the upper end portion 14 and the middle portion 18 may be about eighteen (18) inches to about four (4) feet wide.

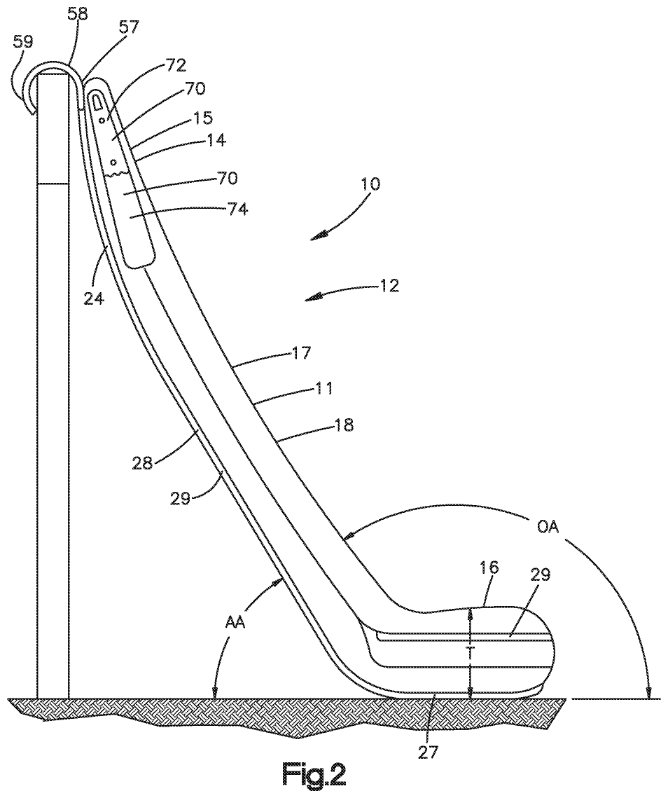

The slide portion 12 is configured to have a length that is greater than the distance between the egress opening and the ground surface upon which the enlarged lower end portion 16 is configured to rest upon. The top surface 17 of the middle portion (and/or the top surface 15 of the upper end portion 14) preferably forms an obtuse angle “OA” with the ground, and an acute angle “AA” (FIG. 2) between the lower surface 28 of the middle portion and the ground.

In an embodiment the inflatable slide and/or portions thereof, including labels, may be color coded to correlate to the length of the slide portion 12. For example, the color red could be used for the second floor of buildings and may have representative lengths of twenty (20) feet to thirty (30) feet; the color orange could be used for the third floor of buildings and may have representative lengths of thirty (30) feet to forty (40) feet; the color yellow may be used for the fourth floor of buildings and may have representative lengths of forty (40) feet to fifty (50) feet; the color green may be used for the fifth floor of buildings and may have representative lengths of fifty (50) feet to sixty-five (65) feet; the color blue may be used for the sixth floor of buildings and may have representative lengths of sixty-five (65) feet to eighty-five (85) feet; and the color purple may be used for the seventh floor of buildings and may have representative lengths of seventy-five (75) feet to ninety-five (95) feet. Other colors and lengths are contemplated for use.

The enlarged lower end portion 16 may be wider than the middle portion 18, and/or upper end portion 14 as seen in FIG. 1. For example, the enlarged lower end portion 16, may have a width from eighteen (18) inches to about six (6) feet. The enlarged lower end portion 16 preferably provides a landing area 19 for the evacuees and preferably provides a cushioned area. The enlarged lower end portion 16 may have a larger thickness “T” than the upper end portion 14 and/or the middle portion 18, and in one embodiment the top surface 26 of the enlarged lower end portion 16 is about eighteen (18) inches to twenty-four (24) inches from the lower surface 27 of the enlarged lower end portion 16 which preferably positions the top surface 26 eighteen (18) inches to twenty-four (24) inches above the ground. One purpose of the enlarged lower end portion 16 is to provide a safe landing for evacuee and to prevent or lower the likelihood of injuries.

In one embodiment, the enlarged lower end portion 16 may include foam 29, preferably formed as a layer. The foam may form or be part of the top surface 26 of the enlarged lower end portion. Additionally or alternatively, the foam may be in the interior of the lower end portion 16, and/or may form or be part of the lower surface 27 of the lower end portion 16 as shown in FIG. 2. In one embodiment, the lower surface 24 of the upper end portion 14, and/or the lower surface 28 of the middle portion 18, and/or the lower surface 27 of the enlarged lower end portion may have a layer of foam 29. The layer of foam may be approximately one (1) inch thick of industrial grade foam, preferably highly buoyant foam. The foam may assist the structural integrity of the slide and may provide increased buoyancy in the event of a flood, where the slide can also be deployed as a flotation or emergency raft (See FIG. 14). The layer of foam 29 may also be fire resistant or fire retardant.

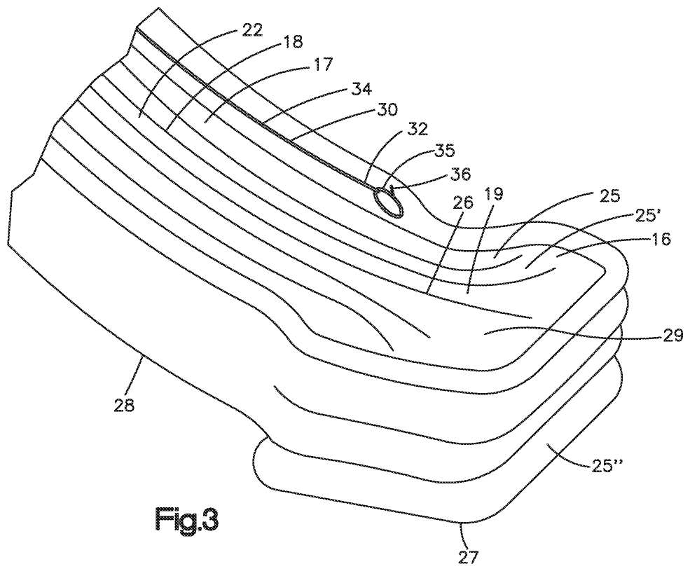

In one embodiment, the slide portion 12 may comprise a plurality of inflatable chambers 25, which preferably run the length “L” of the slide portion 12 as shown in FIGS. 1 and 3. The plurality of inflatable chambers 25, 25′ may be independently inflatable. The raised side portions 20 may have inflatable chambers 25 separate and independent from the one or more inflatable chambers 25 forming the central portion 22. The central portion 22 may include a plurality of chambers 25, 25′, which are preferably independently inflatable. The enlarged lower end portion 16 may have more chambers 25 than the upper end portion 14, and/or the middle portion 18. A plurality of chambers may assist with the structural integrity and rigidity of the slide, and should provide improved reliability and operability in the event that a chamber is defective or punctured or otherwise compromised prior to, during deployment and inflation of, and/or use of the slide 10.

In one embodiment, a safety system is associated with the slide 10 to maintain an evacuee on the slide during their descent. The safety system may include one and preferably a pair of safety cables 30 associated with raised side portions 20 as shown in FIG. 3. The safety cables preferably run the length of the raised side portions 20, but may run more or less than the length of the raised side portions 20. The safety cables 30 may extend in channels 32 formed within the raised side portions 20, and the channels may include a flap 34 covering the opening of the channel 32. Each of the safety cables 30 may have one or more attachment cords 35 slidably coupled thereto. The attachment cords 35 may have hook and loop fasteners disposed thereon for securing the attachment cords 35 to the wrists of users. Other fastening mechanisms for attaching to users is also contemplated. The attachment cords 35 may have one or more loops 36 slidably coupled to the safety cables 30. The attachments cords 35 may releasably attach to or be associated with the loops 36 to associate or couple the attachment cords 35 to the safety cables 30.

In one embodiment, the upper end portion 14 and/or middle portion 18 forms a tubular or enclosed portion 40 as shown in FIGS. 4-6. The tubular portion 40 extends a portion of the length of the slide portion 12 and encloses the top portion of the slide to maintain an evacuee on and within the slide during their descent. The tubular portion 40 is preferred for the longer lengths of the slide, for example slides for greater than three floors. The tubular portion 40 preferably extends until about twenty (20) feet from the ground. The upper portion 42 of the tubular portion 40 may be transparent or translucent and may be formed of fire resistant material or coated with fire resistant material, including fire resistant rubber.

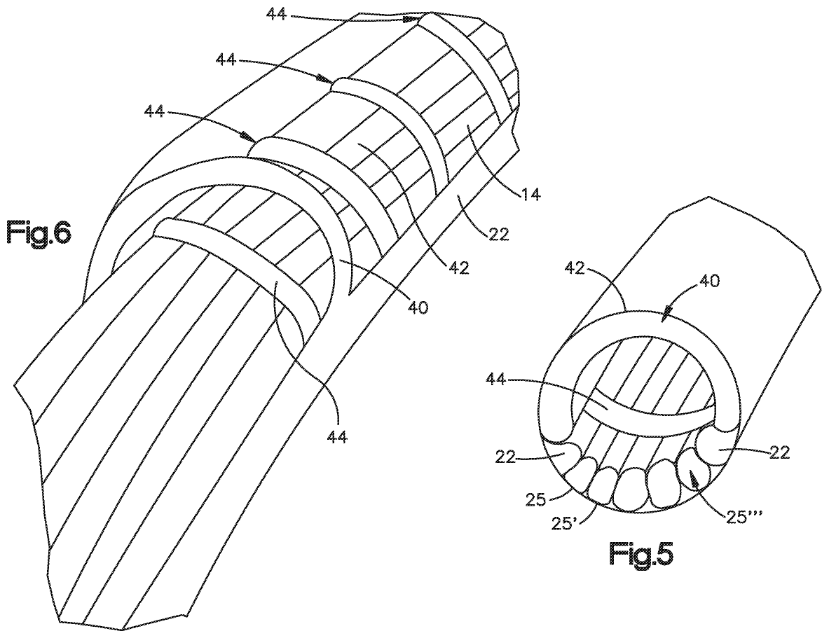

In another embodiment, the slide portion 12 on a top surface 11 may include a plurality of raised sections 44 that form rib-like extensions that extend transverse to the length of the slide portion 12. The plurality of raised sections 44 preferably are dispersed and spread out at a plurality of locations along the length of the slide portion. The raised sections 44 in one embodiment may be provided throughout the tubular potion 40 as shown in FIG. 6. The raised sections 44 preferably extends transverse across the central portion 22, preferably perpendicular to the length of the slide and/or central portion 22. The plurality of raised sections 44 preferably are sized, configured and spaced to slow and control the descent velocity of an evacuee. In one embodiment, the raised sections 44 may be spaced approximately one foot apart, although other spacing distance are contemplated, which may depend upon the size of the raised sections, the friction of the central portion 22 on which the evacuee slides, and the angle of descent. The raised sections 44 may be advantageous and preferred for the longer length slides to slow the descent of the evacuees to increase the safety and decrease the likelihood of injury. Other factors affecting the descent velocity is the angle the slide forms with the ground and the frictional resistance of the top surface 11 of the slide portion 12 and/or central portion 22. The raised sections may be formed in embodiments only on a portion of the slide, for example, only the upper portion 14 and/or the middle portion 18.

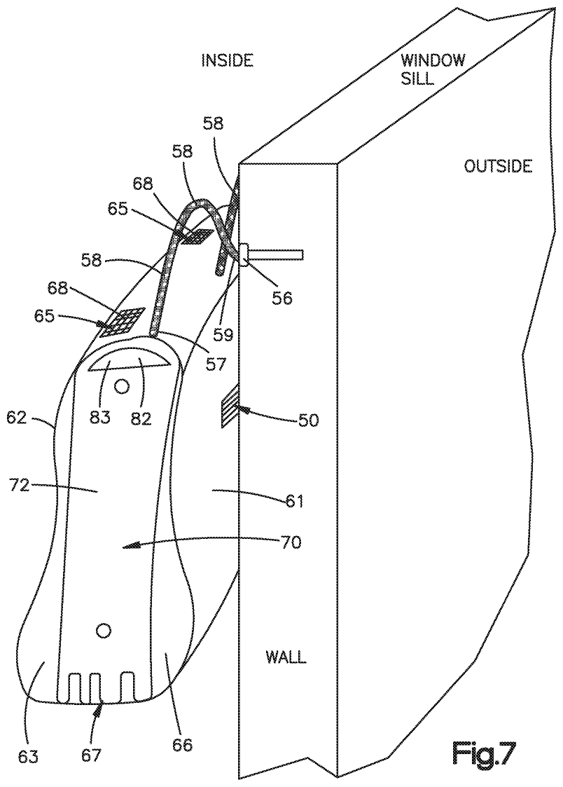

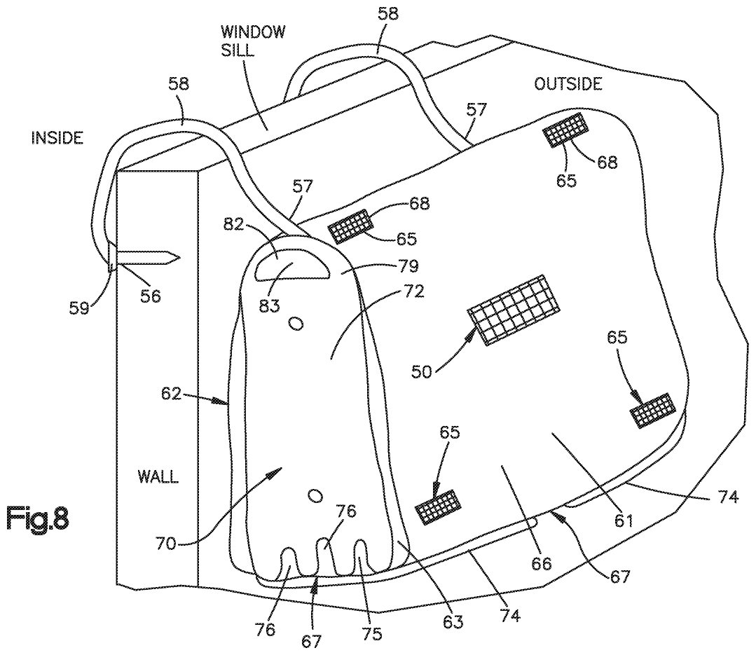

While the system, inflatable slide, and/or emergency raft is not being used it is in a ready state in a packaged condition. In the ready state as shown in FIG. 7, the slide is uninflated, compressed and packaged, preferably so it may be easily moved and deployed. In the packaged condition, the slide is preferably configured to be easily deployed to a deployment position as shown in FIG. 8. In one embodiment, the slide in a ready state is folded and rolled into a compact unit which may be readily inflated so that it takes on an inflated state and is configured for use.

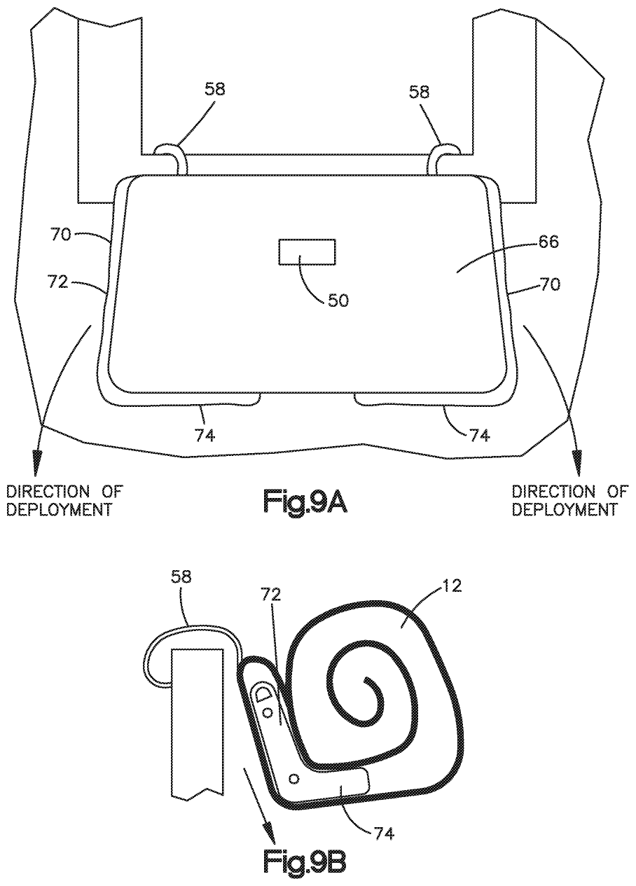

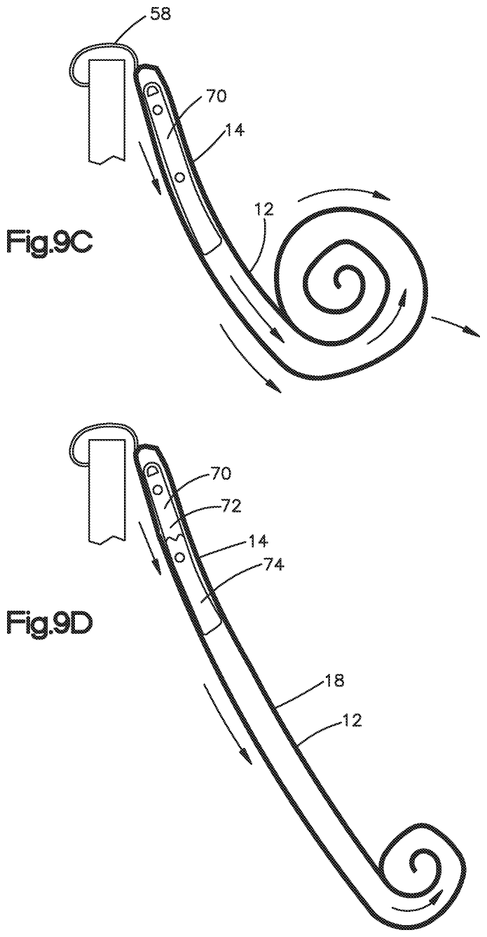

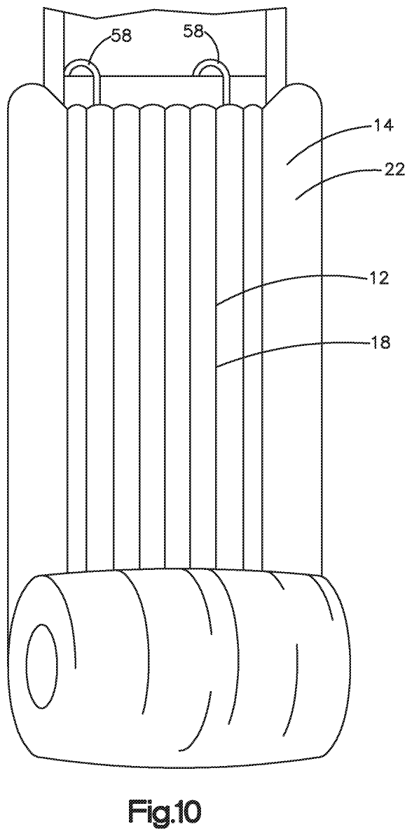

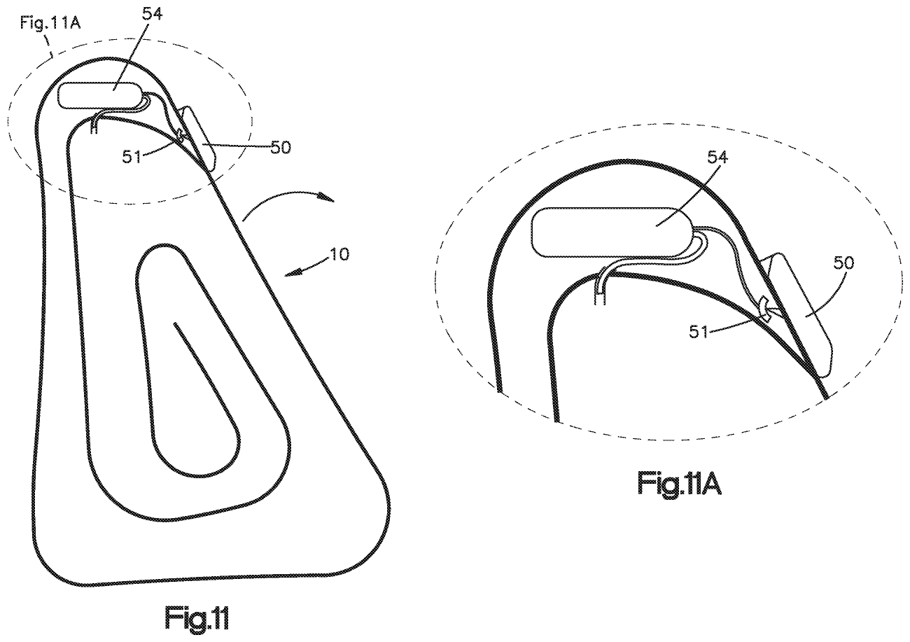

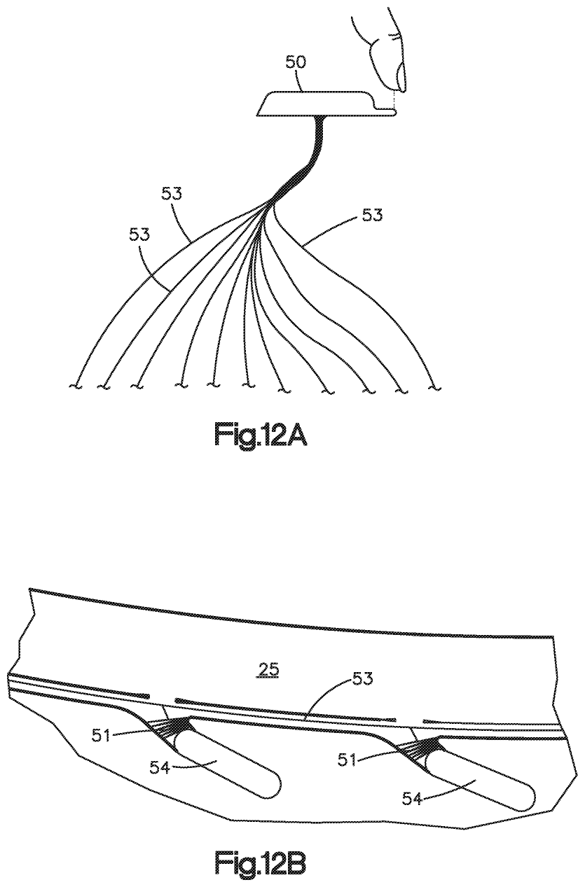

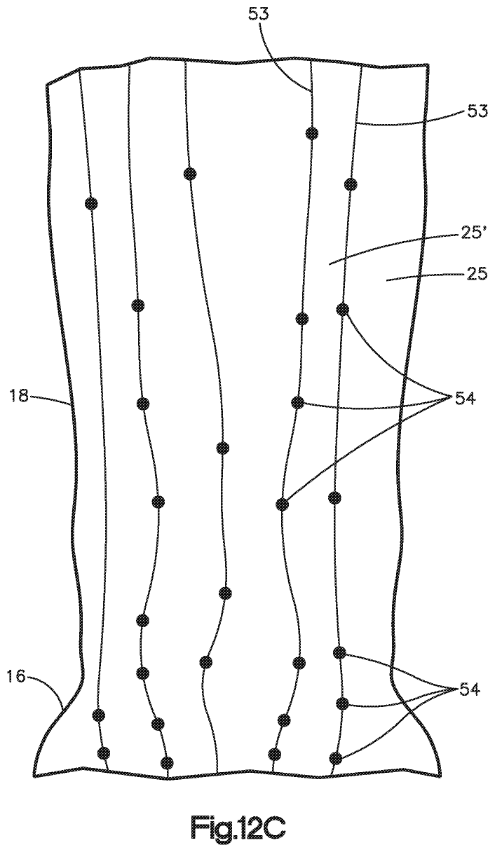

In an aspect, the slide in the ready state has a release button 50 that is pulled by a user to inflate the slide. In an embodiment, the release button 50 is configured to be pulled by a user to inflate the slide to the inflated state or condition. According to one aspect, as shown in FIGS. 11 and 11A, pulling the release button 50 releases the pin 51 of one or more compressed gas canisters 54 to release gas to inflate the slide. The slide preferably has a plurality of compressed gas canisters 54 which are spaced along the length of the slide portion 12 as shown in FIGS. 12B and 12C. The release button 50 is configured as shown in FIG. 12A so that as the release button 50 is pulled, tension wires 53 pull the one or more pins 51 on one or more of the compressed gas canisters 54 which releases gas and starts to inflate the slide 10. As the slide 10 inflates it starts to unfold and unroll as gravity and the pressure from the released gas fills the interior portions of the slide. As the slide unfolds and unrolls, as shown in FIGS. 9A-9D and FIG. 10, the energy and motion of the unrolling slide releases the pins of additional compressed gas canisters 54 so that the slide continues to unfold, unroll, inflate and extend to the ground until all the pins 51 of the compressed gas canisters 54 are pulled and the slide is fully inflated and deployed as shown in FIG. 12C. The compressed gas canisters 54 are preferably arranged so that they trigger in sequence as the slide unrolls as it undergoes the inflation process. The pins 51 of the canisters 54 may be arranged so that as the slide unfolds and inflates, movement of the slide portion 12 pulls the release pins 51, or additionally or alternatively, tension wires may be used to pull the release pins. The upper end portion 14 of the slide preferably inflates before the middle portion 18 or enlarged end portion 16, with the middle portion 18 thereafter filling with gas, followed by the enlarged lower portion 16 as shown in FIGS. 9A-9D and FIG. 10. The slide may have one or more compressed gas canisters 54 per inflatable chamber 25. The enlarged lower end portion 16 may have more gas canisters 54 to fill the larger volume. In one aspect, the compressed gas in the one or more canisters 54 may include CO₂ and preferably is essentially only CO₂. Other inflation gases, preferably gases that would not create a fire hazard, may be used. Additional to or alternatively, the inflatable slide 10 may include an aspirator 55 associated with and activated by the release button 50 to draw air into the slide portion to inflate the slide 10. While inflating the slide has been described as utilizing a plurality of compressed gas canisters 54, it should be appreciated that one compressed gas canister 54 may be utilized depending upon the design and desired characteristics of the inflatable slide.

In one embodiment, the slide in the ready state is preferably stored indoors in the interior of the building as shown in FIG. 7 so that it is not subject to the exterior environmental conditions, which may affect the durability and longevity of the slide. In one aspect, the slide includes a mechanism for securing the slide to the building so that it may be deployed in proximity to an egress opening, e.g., a window, as shown in FIG. 7. In one embodiment, the slide in the ready state is secured to the building, preferably to the interior of the building, in a ready position preferably in proximity to an egress opening and moveable to the exterior of the building to a deployment position where the slide may be inflated and deployed as shown in FIG. 8.

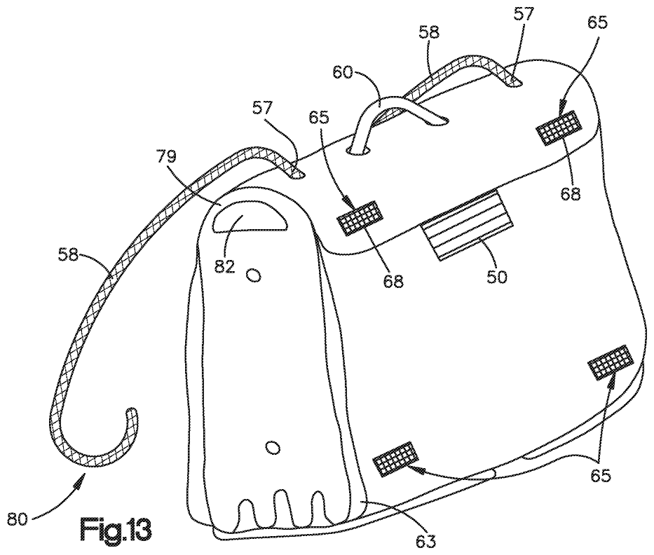

In one embodiment, the slide may include one or more securement cables or straps 58 for securing the slide to the building, preferably the interior of the building. The securement straps 58 preferably extend from the slide in the packaged condition as shown in FIGS. 7 & 8. The first end 57 of the securement straps 58 are preferably associated with, for example, secured or coupled to, the slide portion 12, preferably the upper end portion 14 of the slide. The securement straps 58 extend from the slide portion 12, extend outside the slide packaging 66, and the second ends 59 of the securement straps 58 are preferably secured to the building during the inflation state, or condition, and preferably while in the deployment position. The securement straps 58 preferably are of sufficient strength to reliably secure the slide 10 and potential load (weight) of the evacuees. In one embodiment, the second end 59 of the securement strap 58 is secured to the building, preferably the interior of the building. In one embodiment, the securement straps 58 are fastened to the building, the interior of the building, using bolts 56. Other fasteners for securing and anchoring the securement straps 58 and/or the slide to the building, preferably the interior of the building, are contemplated. The securement straps 58 may be as shown in FIGS. 7 & 8 releasably attachable to the slide, and additionally or alternatively may be releasably attachable to the building. In another embodiment, particularly useful for portable models of the evacuation slide, the securement straps 58 may be U-shaped hook members 80 as shown in FIG. 13 that grab onto the ledge or sill of the egress opening. The slide 10 in the ready state is preferably positioned in a ready position inside the building but is preferably readily moveable to a deployable position outside the building and secured to the building as shown in FIGS. 7 & 8. In this regard, the securement straps 58 are of sufficient length so that the slide in the ready state can be moved from inside the building to outside the building through the egress opening.

In one configuration, the slide in the ready state in the packaged condition has the release button 50 arranged and positioned so that it is on the back surface 61 facing the inside wall of the building as shown in FIG. 7 so that it is not easily accessible in the ready position. In this manner the release button 50 will be less likely to be prematurely and inadvertently released while the slide is inside the building and before the slide is needed. The release button 50 is preferably arranged and positioned on the back surface 61 so that when the slide is in the deployed position the button is facing outside and readily accessible by a user as shown in FIG. 8. As shown in FIGS. 7 & 8, in the ready position the back surface 61 of the packaged slide faces the interior wall of the building while in the deployed position the front surface 62 faces the outside building wall while the back surface 61 faces outward and is readily accessible by a user.

The slide in the packaged condition may further be associated with one or more sensors 65 as shown in FIGS. 7, 8 and 13 to detect an emergency situation, such as, for example, a fire or smoke condition. The sensors 65 may be associated with the packaging 66, which retains the slide in the ready state. The sensors 65 may be associated with an alarm 68. The alarm 68 may provide a visible and/or auditory alert. The sensor 65 may detect heat, smoke, CO₂, or other conditions that may indicate a dangerous situation. For example, the alarm(s) 68 may provide auditory instructions, flash, provide siren noises, and/or beep. The sensors may flash different colors, for example, yellow, white, and/or red. The sensors 65 and alarms 68 may be associated with or on a top surface of the packaging 66 in the ready state to facilitate detecting smoke, heat, CO₂, and other conditions.

As described above, the slide in its ready state may be folded, rolled, and packaged into a compact form that would be portable as shown in FIG. 13. In one aspect, the slide in the ready state may include a handle 60 as shown in FIG. 13 to facilitate moving and/or carrying the slide, for example, by emergency response personnel. The securement straps 58 in the portable version may be formed as U-shaped hook members 80 to grab onto a window sill or ledge and may include rigid portions to assist with securing the slide. The slide may also include wheels 85 to assist with moving the slide in the ready state and packaged condition.

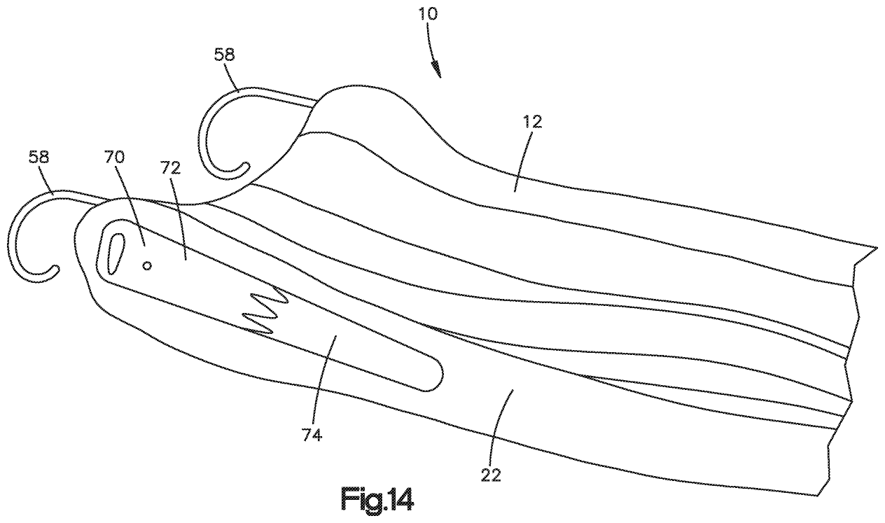

In one embodiment, the slide may include one or more side members 70 preferably a pair of side support members 70 preferably positioned and arranged along package side surfaces 63, 64 in the packaged condition as shown in FIGS. 7, 8, and 15 and preferably associated with and positioned along the raised side portions 20 or the central portions 22 of the upper end portion 14 of the slide in the inflated state as shown in FIGS. 2, 9B-9D, and 14. The side support members 70 preferably provide structural support to the packaging 66 of the slide in the ready state to assist with movement, and preferably provide structural support to the slide in the inflatable state. The side support members 70 preferably are made from rigid or semi-rigid materials and in one embodiment may be formed of heat resistant plastic. The side support members 70 in one configuration are releaseably attached to the slide portion 12 and preferably the upper end portion 14 of the slide. The side support members 70 may be releaseably attached to the slide portion 12 by turn buckles 71 as shown in FIGS. 15 and 17.

The side support members 70 in one embodiment may comprise two connectable sections 72, 74 that are moveable with respect to each other, preferably between a first position as shown in FIGS. 7, 8 and 15 when the slide is in the ready state, and a second position as shown in FIGS. 2, 9D and 14 when the slide 10 is in the inflated state. In the first position, the two connectable sections 72, 74 are at an angle with respect to each other wherein the first connectable sections 72 are alongside or forms at least a part of the side surfaces 63, 64 of the packaging 66, and the second connectable sections 74 are along side or form part of the bottom surface 67 of the packaging 66. In the second position, when the slide is in the inflated state, the first and second connectable sections 72, 74 are preferably positioned and aligned in a straight line as shown in FIGS. 2, 9D and 14. As the slide inflates the second connectable section 74 moves and pivots with respect to the first connectable section 72 as shown in FIGS. 9A-9C. The first and second sections are preferably attached and moveable through a knuckle joint 75 and may comprise one or more intermeshing fingers 76 with a shaft or pin 78 to permit articulating or pivoting movement. The first and second sections 72, 74 may be lockable in the second position where the sections 72, 74 are aligned in a straight line. In this regard, greater resistance may be provided and/or greater force may be required to move the first and second sections 72, 74 out of a straight line.

The side support members 70, and preferably the top 79 of the first connectable section 72, may be provided with handle 82 that permits a user to readily grab the side support members 70 as shown in FIGS. 7, 8 and 13. The handle 82 may be an opening 83 formed in the side support members 70 that is sized and configured for gripping by a user. The handles 82 formed in the side support members 70 may provide a ready manner to move, manipulate and/or carry the slide in its ready state. The side support members 70 may be configured to form oars that may be releasably attached to the slide as shown in FIG. 15. The side support members 70 may be releasably attached to the slide by use of turn buckles 78. In this manner, in situations where the slide forms and is used as an emergency floatation raft, oars for maneuvering the raft are provided with the slide as shown in FIGS. 14-16.

In a further embodiment, the side members 10 may comprise wheels 85, and the wheels 85 may be associated with, preferably attached to the second connectable section 74. In the ready state, the wheels associated with the second connectable section 74 are preferably along the bottom surface 67 of the packaged slide 66 as shown in FIG. 15.

The materials of construction in a preferred embodiment include fire resistant and/or fire retardant materials. As to the manner of usage and operation of the system, the same should be apparent form the above description. Accordingly, no further discussion relating to the manner of usage and operation will be provided. With respect to the above description, it is to be realized that the optimum dimensional relationship for the parts of the system includes variations in size, materials, shape, form, function and the manner of operation known to one skilled in the art, and all equivalent relationships to those illustrated in the drawings and described in the specification are intended to be encompassed by the invention.

Those skilled in the art will recognize that the system, evacuation slide, and/or emergency raft has many applications, may be implemented in various manners and, as such is not to be limited by the foregoing embodiments and examples, but it is intended to cover modifications within the spirit and scope of the invention. While fundamental features of the invention have been shown and described in exemplary embodiments, it will be understood that omissions, substitutions, and changes in the form and details of the disclosed embodiments of the architectural covering may be made by those skilled in the art without departing from the spirit of the invention. Any number of the features of the different embodiments described herein may be combined into a single embodiment. The locations of particular elements, for example, the tubular portion, raised sections, compressed gas canisters, the release button, etc., may be altered. Alternate embodiments are possible that have features in addition to those described herein or may have less than all the features described. Functionality may also be, in whole or in part, distributed among multiple components, in manners now known or to become known.

In the claims, the term “comprises/comprising” does not exclude the presence of other elements, features, or steps. Furthermore, although individually listed, a plurality of means, elements, or method steps may be implemented by, e.g., a single unit, element, or piece. Additionally, although individual features may be included in different claims, these may advantageously be combined, and their inclusion individually in different claims does not imply that a combination of features is not feasible and/or advantageous. In addition, singular references do not exclude a plurality. The terms “a”, “an”, “first”, “second”, etc., do not preclude a plurality. Reference signs or characters in the disclosure and/or claims are provided merely as a clarifying example and shall not be construed as limiting the scope of the claims in any way.

The foregoing description has broad application. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

1. An inflatable slide for securing to a building having an egress opening located above a ground surface for providing egress in an emergency situation, the slide comprising:
a ready state and an inflated state, wherein in the ready state the slide is uninflated and in a packaged more compact and smaller condition and in the inflated state the slide is inflated into a larger inflated condition;
an elongated self-inflating slide portion that in the inflated condition has an upper end portion, an enlarged lower end portion and a middle portion therebetween, the elongated self-inflating slide portion further including a pair of raised side portions to assist with retaining an evacuee on the elongated self-inflating slideportion, the upper portion being securable to the building, the elongated self-supporting slide portion configured to have a length in its inflated state that is larger than the distance between the ground and the egress opening such that the enlarged lower end portion creates an obtuse angle with a top sliding surface of the middle portion; and
a release button for converting the slide from the ready state to the inflated state by inflating the elongated self-inflating slideportion,
wherein the slide in a packaged condition is moveable from a ready position inside the building to a deployed position outside the building, wherein the release button in the ready position is arranged and configured to face an interior wall of the building, and in the deployed position is arranged and configured to face outward and be readily accessible by a potential evacuee.

2. The inflatable slide of claim 1, wherein the slide portion includes one or more securernent straps attached to the upper end portion of the slide portion, the one or more straps configured for securing to the building.

3. (canceled)

4. The inflatable slide of claim 1, wherein the straps have a first end releasably attachable to the upper end portion, and wherein the second end of the one or more straps are releasably attachable to the inside of the building, the one or more straps attachableby at least one of a securing bolt, U-shaped hook members, and combinations thereof.

5. (canceled)

6. The inflatable slide of claim 1, wherein the release button is configured to be pulled by a user to inflate the slide to the inflated condition, wherein pulling the release button releases one or more pins of one or more compressed gas canisters to inflate and deploy the inflatable slide.

7. (canceled)

8. The inflatable slide of claim 1, wherein the slide portion comprises a plurality of compressed gas canisters arranged, configured and spaced apart along the length of the slide portion which during inflation of the slide portion are triggered in sequence to release gas and inflate the slide portion as the slide portion unrolls frog its packaged condition to its deployed condition.

9. The inflatable slide of claim 1, wherein the inflatable slide includes an aspirator associated with and activated by the release button to draw air into the slide portion to inflate the slide portion.

10. (canceled)

11. The inflatable slide of claim 1, further comprising a tubular section associated with the top portion that extends a portion of the length of the slide portion, the tubular section configured to enclose at least a portion of the top end portion to retain an evacuee from falling off the evacuation slide.

12. The inflatable slide of claim 11, wherein the tubular section is substantially transparent or translucent and extends from the top portion to approximately 20 feet from the enlarged lower end portion.

13. (canceled)

14. The inflatable slide of claim 1, further comprising in the inflated condition a plurality of raised sections configured to extend transverse to the length of the slide portion and dispersed at a plurality of locations along the length of the slide portion to control the descent velocity of an evacuee as they slide down the slide portion.

15. The inflatable slide of claim 1, further comprising one or more sensors to detect an emergency situation, and further comprising an alarm system that provides a visible or auditory alarm.

16. The inflatable slide of claim 1, further comprising a plurality of independently inflatable channels running the length of the slide portion.

17. The inflatable slide of claim 1, wherein a lower surface of the enlarged lower end portion is configurable in the inflated condition to rest on the ground and an upper surface of the enlarged lower end portion is configurable to be one and a half (1.5) feet to two (2) feet above the lower surface.

18. The inflatable slide of claim 1, wherein the inflatable slide consists of at least one of the group including an enlarged lower end that includes foam, a foam layer on the underside of at least a portion of the slide portion, and combinations thereof.

19. (canceled)

20. The inflatable slide of claim 1, configured and arranged to be portable and comprising a handle.

21. (canceled)

22. The inflatable slide of claim 1, further comprising side support members, the support members positioned and arranged along package sides in the packaged condition, and associated with and positioned along the raised side portions of the upper end portion of the slide in the inflatable condition to provide support to the slide portion.

23. (canceled)

24. The inflatable slide of claim 22, wherein the side support members are releasably attached to the slide portion.

25. The inflatable slide of claim 22, wherein each side support member comprises two connectable sections that are moveable with respect to each other between a first position and a second position, wherein in the first position the two connectable sections are at an angle with respect to each other and in the second position the two connectable sections are aligned in a substantially straight line, and further wherein in the packaged condition the first connectable section in the first position is connected along one side of the packaged slide and the second connectable section is positioned along the bottom surface of the packaged slide.

26. (canceled)

27. (canceled)

28. (canceled)

29. (canceled)

30. (canceled)

31. The inflatable slide of claim 1, further comprising a safety system, the safety system including a pair of cables associated with the raised side portions, each of the cables having an attachment cord configured for attachment to a potential evacuee and attachable to and moveable along the cable to secure an evacuee during descent.

32. An inflatable slide for securing to a building having an egress opening located above a ground surface for providing egress in an emergency situation, the slide comprising:
a ready state and an inflated state, wherein in the ready state the slide is uninflated and in a packaged more compact and smaller condition and in the inflated state the slide is inflated into a larger inflated condition;
an elongated self-inflating slide portion that in the inflated condition has an upper end portion, an enlarged lower end portion and a middle portion therebetween, the elongated self-inflating slide portion further including a pair of raised side portions to assist with retaining an evacuee on the elongated self-inflating slide portion, the upper portion being securable to the building, the elongated self-inflating slide portion configured to have a length in its inflated state that is larger than the distance between the ground and the egress opening such that the enlarged lower end portion creates an obtuse angle with a top sliding surface of the middle portion;
a release button for converting the slide from the ready state to the inflated state by inflating the elongated self-inflating slide portion; and
side support members, the side support members positioned and arranged along package sides in the ready state, and associated with and positioned along the raised side portions of the upper end portion of the slide in the inflated state to provide support to the elongated self-inflating slide portion.

33. An inflatable slide for securing to a building having an egress opening located above a ground surface for providing egress in an emergency situation, the slide comprising:
a ready state and an inflated state, wherein in the ready state the slide is uninflated and in a packaged more compact and smaller condition and in the inflated state the slide is inflated into a larger inflated condition;
an elongated self-inflating slide portion that in the inflated condition has an upper end portion, an enlarged lower end portion and a middle portion therebetween, the elongated self-inflating slide portion further including a pair of raised side portions to assist with retaining an evacuee on the elongated self-inflating slide portion, the upper portion being securable to the building, the elongated self-inflating slide portion configured to have a length in its inflated state that is larger than the distance between the ground and the egress opening such that the enlarged lower end portion creates an obtuse angle with a top sliding surface of the middle portion;
a release button for converting the slide from the ready state to the inflated state by inflating the elongated self-inflating slide portion; and
one or more securement straps attachable to the upper end portion of the elongated self-inflating slide portion, the one or more securement straps configured to be securable to the inside of the building.
